(19) United States
(12) Patent Application Publication
(10) Pub. No.: US 2024/0266678 A1
(43) Pub. Date: Aug. 8, 2024

(54) SECONDARY BATTERY

(71) Applicant: MURATA MANUFACTURING CO., LTD., Kyoto (JP)

(72) Inventor: Shuichi NAGAOKA, Kyoto (JP)

(21) Appl. No.: 18/637,100

(22) Filed: Apr. 16, 2024

Related U.S. Application Data
(63) Continuation of application No. PCT/JP2022/042724, filed on Nov. 17, 2022.

(30) Foreign Application Priority Data
Nov. 26, 2021 (JP) 2021-192473

(51) Int. Cl. H01M 50/477; H01M 50/119; H01M 50/474; H01M 50/486

(52) U.S. Cl. CPC H01M 50/477; H01M 50/119; H01M 50/474; H01M 50/486

(57) ABSTRACT

A secondary battery includes an electrode assembly formed by stacking at least one electrode constituting layer including a positive electrode, a negative electrode, and a separator, and an exterior body covering the electrode assembly. In the secondary battery, a current collector extending from the positive electrode and/or the negative electrode of the electrode assembly protrudes as an electrode lead from the exterior body, the entire one main surface of a protruding portion of the current collector protruding from the exterior body is covered with a resin member, and at least a part of the current collector is sandwiched by the resin member inside the exterior body.

### CROSS REFERENCE TO RELATED APPLICATIONS

The present application is a continuation of PCT patent application no. PCT/JP2022/042724, filed on Nov. 17, 2022, which claims priority to Japanese patent application no. 2021-192473, filed on Nov. 26, 2021, the entire contents of which are incorporate herein by reference.

### BACKGROUND

The present disclosure relates to a secondary battery. In particular, the present disclosure relates to a secondary battery provided with an electrode assembly including an electrode constituting layer including a positive electrode, a negative electrode, and a separator.

Secondary batteries are so-called storage batteries and therefore can be repeatedly charged and discharged, and the secondary batteries are used in various applications. For example, secondary batteries are used for mobile devices such as mobile phones, smart phones and notebook computers.

### SUMMARY

The present disclosure relates to a secondary battery. In particular, the present disclosure relates to a secondary battery provided with an electrode assembly including an electrode constituting layer including a positive electrode, a negative electrode, and a separator.

The inventor of the present application has noticed that there is a problem to be overcome in the previously secondary battery, and has found a need to take measures therefor.

For example, a secondary battery is provided in which an electrode lead protrudes outward from a battery case.

As schematically illustrated in FIG. 19, for example, a conventional secondary battery 100 is configured such that an electrode lead 111 electrically connected to an electrode assembly 110 protrudes outward (rightward) from a battery case 120 (for example, a battery case that can include a first case 120a (upper case) and a second case 120b (lower case)). The electrode lead 111 is generally provided with an insulating member (for example, an insulating member that can include a first insulating member 112a (upper insulating member) and a second insulating member 112b (lower insulating member)), and by sandwiching the electrode lead 111 from above and below with such an insulating member, the electrode lead 111 is fixed and a sealing property is secured.

In the conventional secondary battery 100 having such a configuration, at the time of use and/or during use, stress concentrates on a portion indicated by an arrow in FIG. 19, particularly, a root portion of the protruding electrode lead, and there is a possibility that the electrode lead 111 is broken.

The present disclosure has been devised in view of such problems according to an embodiment. For example, the present disclosure relates to providing a secondary battery including a reinforced electrode lead according to an embodiment.

In an embodiment, the present disclosure provides a secondary battery including: an electrode assembly formed by stacking at least one electrode constituting layer including a positive electrode, a negative electrode, and a separator; and an exterior body covering the electrode assembly, in which a current collector extending from the positive electrode and/or the negative electrode of the electrode assembly protrudes as an electrode lead from the exterior body, the entire one main surface of a protruding portion of the current collector protruding from the exterior body is covered with a resin member, and at least a part of the current collector is sandwiched by the resin member inside the exterior body.

In the present disclosure, a secondary battery including a reinforced electrode lead is obtained according to an embodiment.

### BRIEF DESCRIPTION OF THE FIGURES

FIG. 1 is a sectional view schematically illustrating a configuration of an electrode assembly.

FIG. 2 is a schematic view schematically illustrating a concept of a secondary battery of the present disclosure.

FIG. 3 is a schematic view schematically illustrating the secondary battery according to an embodiment of the present disclosure.

FIG. 4 is a schematic view schematically illustrating manufacture of the secondary battery according to an embodiment of the present disclosure.

FIG. 5 is a schematic view schematically illustrating an internal structure (part) of the secondary battery according to an embodiment of the present disclosure.

FIG. 6A is a schematic view schematically illustrating the internal structure (particularly, a resin member) of the secondary battery according to an embodiment of the present disclosure.

FIG. 6B is a schematic view schematically illustrating the internal structure (particularly, the resin member) of the secondary battery according to an embodiment of the present disclosure.

FIG. 7 is a schematic view schematically illustrating the internal structure (particularly, an electrode assembly) of the secondary battery according to an embodiment of the present disclosure.

FIG. 8 is a schematic sectional view schematically illustrating a section in a width direction of the secondary battery according to an embodiment of the present disclosure.

FIG. 9 is a schematic sectional view schematically illustrating a section in a longitudinal direction of the secondary battery according to an embodiment of the present disclosure.

FIG. 10 is a schematic view schematically illustrating a secondary battery according to an embodiment of the present disclosure.

FIG. 11 is a schematic sectional view schematically illustrating a section in the longitudinal direction of the secondary battery according to an embodiment of the present disclosure.

FIG. 12 is a schematic view schematically illustrating a secondary battery according to an embodiment of the present disclosure.

FIG. 13 is a schematic sectional view schematically illustrating a section in the longitudinal direction of the secondary battery according to an embodiment of the present disclosure.

FIG. 14A is a schematic sectional view schematically illustrating a usage mode of the secondary battery according to an embodiment of the present disclosure.

FIG. 14B is a schematic sectional view schematically illustrating the usage mode of the secondary battery according to an embodiment of the present disclosure.

FIG. 15A is a schematic sectional view schematically illustrating a usage mode of the secondary battery according to an embodiment of the present disclosure.

FIG. 15B is a schematic sectional view schematically illustrating the usage mode of the secondary battery according to an embodiment of the present disclosure.

FIG. 16A is a schematic sectional view schematically illustrating a usage mode of the secondary battery according to an embodiment of the present disclosure.

FIG. 16B is a schematic sectional view schematically illustrating the usage mode of the secondary battery according to an embodiment of the present disclosure.

FIG. 17 is a schematic view schematically illustrating a secondary battery according to an embodiment of the present disclosure.

FIG. 18 is a schematic view schematically illustrating a secondary battery according to an embodiment of the present disclosure.

FIG. 19 is a schematic sectional view schematically illustrating a conventional secondary battery.

### DETAILED DESCRIPTION

Hereinafter, the present disclosure will be described in more detail including with reference to a secondary battery according to an embodiment of the present disclosure. Although the description will be made with reference to the drawings if necessary, various elements in the drawings are only schematically and exemplarily illustrated for the understanding of the present disclosure, and appearances and/or dimensional ratios may be different from actual ones. Hereinafter, the secondary battery is referred to as a “secondary battery of the present disclosure” or simply as a “secondary battery”.

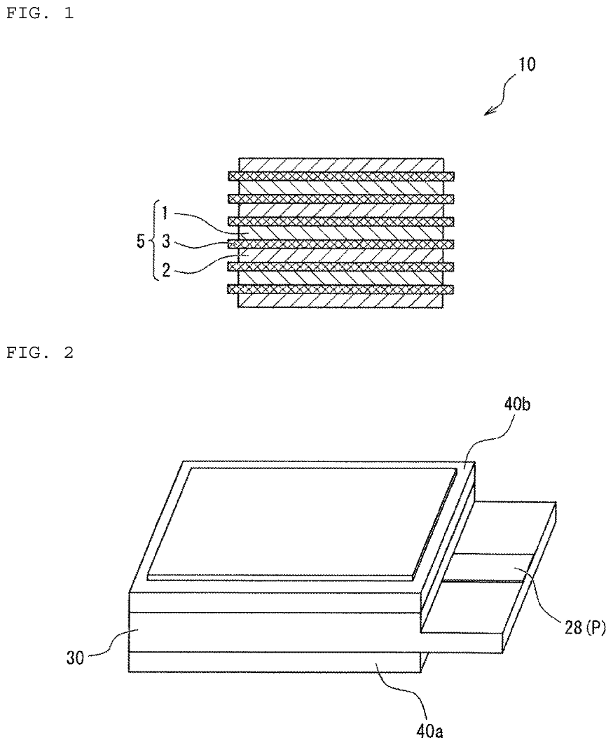

The “sectional view” described directly or indirectly in the present specification is basically based on a virtual cross section obtained by cutting the secondary battery along a stacking direction or an overlapping direction of the electrode assembly or the electrode constituting layer that constitute the secondary battery (refer to FIG. 1). Similarly, the direction of a “thickness” described directly or indirectly in the present specification is basically based on the stacking direction of the electrode materials constituting the secondary battery. For example, in the case of a “plate-like secondary battery having a thickness”, the “thickness” direction corresponds to a plate thickness direction of the secondary battery. The term “plan view” or “plan view shape” used in the present specification is based on a sketch drawing when an object is viewed from the upper side or the lower side along the thickness direction (that is, the stacking direction).

Further, the “vertical direction” and “horizontal direction” used directly or indirectly in the present specification correspond to a vertical direction and a horizontal direction in the drawings, respectively. Unless otherwise specified, the same reference numerals or symbols indicate the same members or portions or the same semantic contents. In a suitable aspect, when the stacking direction of an electrode assembly can correspond to the vertical direction, it can be understood that a vertical downward direction (that is, a direction in which gravity acts) corresponds to the term “downward direction” and the opposite direction corresponds to the term “upward direction”.

In the present specification, the term “secondary battery” refers to a battery that can be repeatedly charged and discharged. Therefore, the secondary battery of the present disclosure is not excessively limited by its name, and for example, a power storage device and the like can also be included in the target.

The secondary battery of the present disclosure includes, for example, an electrode assembly formed by stacking at least one electrode constituting layer including a positive electrode, a negative electrode, and a separator. For example, FIG. 1 schematically illustrates an electrode assembly 10. As illustrated, a positive electrode 1 and a negative electrode 2 may be stacked with a separator 3 interposed therebetween to form an electrode constituting layer 5. The electrode assembly may be configured by stacking at least one or more of the electrode constituting layers 5. In FIG. 1, the electrode constituting layer 5 has a planar stacking type structure in which the electrode constituting layers 5 are stacked in a planar shape. In the secondary battery, such an electrode assembly may be covered with an exterior body together with an electrolyte (for example, a non-aqueous electrolyte). The structure of the electrode assembly is not necessarily limited to the planar stacking type structure. For example, the electrode assembly may have a wound lamination type structure. Alternatively, the electrode assembly may have a so-called stack-and-folding type structure in which the positive electrode, the separator, and the negative electrode are stacked on a long film and then folded.

The positive electrode may include at least a positive electrode material layer and a positive electrode current collector. For the positive electrode, for example, a positive electrode material layer may be provided on at least one surface of a positive electrode current collector. The positive electrode material layer contains a positive electrode active material as an electrode active material. For example, for the plurality of positive electrodes in the electrode assembly, for each of the electrodes, the positive electrode material layer may be provided on both sides of the positive electrode current collector, or may be provided only on one side of the positive electrode current collector. For example, the positive electrode current collector may have a foil form. That is, the positive electrode current collector may be formed of a metal foil.

The negative electrode may include at least a negative electrode material layer and a negative electrode current collector. For the negative electrode, for example, a negative electrode material layer may be provided on at least one surface of a negative electrode current collector. The negative electrode material layer contains a negative electrode active material as an electrode active material. For example, for the plurality of negative electrodes in the electrode assembly, for each of the electrodes, the negative electrode material layer may be provided on both sides of the negative electrode current collector, or may be provided only on one surface of the negative electrode current collector. For example, the negative electrode current collector may have a foil form. That is, the negative electrode current collector may be formed of a metal foil.

The electrode active materials that can be contained in the positive electrode material layer and the negative electrode material layer, that is, the positive electrode active material and the negative electrode active material are substances that can directly participate in the transfer of electrons in the secondary battery, and are main substances of the positive electrode and the negative electrode that are responsible for charge and discharge, that is, a battery reaction.

More specifically, ions can be brought in the electrolyte due to the “positive electrode active material which can be contained in the positive electrode material layer” and the “negative electrode active material which can be contained in the negative electrode material layer”. Such ions move between the positive electrode and the negative electrode to transfer electrons, and charging and discharging are performed.

The positive electrode material layer and the negative electrode material layer may be layers particularly capable of occluding and releasing lithium ions. That is, the secondary battery according to an embodiment of the present disclosure may be a non-aqueous electrolyte secondary battery in which lithium ions can move to charge and discharge the battery with the non-aqueous electrolyte interposed between the positive electrode and the negative electrode.

When the lithium ions are involved in charging and discharging, the secondary battery according to an embodiment of the present disclosure may correspond to a so-called “lithium ion battery”. In the lithium ion battery, a positive electrode and a negative electrode have a layer capable of occluding and releasing lithium ions.

The positive electrode active material of the positive electrode material layer can be formed of, for example, a granular material, and a binder may be contained in the positive electrode material layer for sufficient contact between particles and shape retention. A conductive auxiliary agent ma y be contained in the positive electrode material layer in order to more smoothly transfer of electrons promoting the battery reaction.

The negative electrode active material of the negative electrode material layer can be formed of, for example, a granular material, and a binder may be contained in the negative electrode material layer for sufficient contact between particles and shape retention. A conductive auxiliary agent ma y be contained in the negative electrode material layer in order to more smoothly transfer of electrons promoting the battery reaction.

The positive electrode material layer and the negative electrode material layer can be respectively referred to also as a “positive electrode mixture layer” and a “negative electrode mixture layer”, because multiple components are contained therein described above.

The positive electrode active material may be, for example, a material that contributes to occlusion and release of lithium ions. From such a viewpoint, the positive electrode active material may be, for example, a lithium-containing composite oxide. More specifically, the positive electrode active material may be a lithium-transition metal composite oxide containing lithium and at least one transition metal selected from the group consisting of cobalt, nickel, manganese, and iron.

That is, in the positive electrode material layer of the secondary battery according to an embodiment of the present disclosure, such a lithium transition metal composite oxide may be contained as a positive electrode active material. For example, the positive electrode active material may be a lithium cobaltate, a lithium nickelate, a lithium manganate, a lithium iron phosphate, or a material obtained by replacing a part of the transition metal thereof with another metal.

Such positive electrode active materials may be included as a single species, or two or more species thereof may be included in combination.

The binder that can be included in the positive electrode material layer is not particularly limited, and examples thereof include polymer compounds. Specific examples thereof include at least one selected from the group consisting of a styrene-butadiene-based rubber, a polyacrylic acid, a polyimide-based resin, a polyamideimide-based resin, a polyvinylidene fluoride, a vinylidene fluoride-hexafluoropropylene copolymer, a vinylidene fluoride-tetrafluoroethylene copolymer, and a polytetrafluoroethylene.

The conductive auxiliary agent that can be included in the positive electrode material layer is not particularly limited, and examples thereof can include at least one selected from the group consisting of carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, polyphenylene derivatives, and the like.

The thickness dimension of the positive electrode material layer is not particularly limited, and may be 1 μm or more and 300 μm or less, and is, for example, 5 μm or more and 200 μm or less. The thickness dimension of the positive electrode material layer is a thickness inside the secondary battery, and the average value of measured values at random 10 points may be employed.

The negative electrode active material may be a material that contributes to occlusion and release of lithium ions. From such a viewpoint, the negative electrode active material may be various carbon materials, oxides, and/or lithium alloys, metallic lithium, or the like.

Examples of various carbon materials of the negative electrode active material include at least one selected from the group consisting of graphite (specifically, natural graphite and/or artificial graphite), hard carbon, soft carbon, and/or diamond-like carbon. In particular, graphite is high in electron conductivity and is excellent in adhesiveness to, for example, a negative electrode current collector.

Examples of the oxides for the negative electrode active material include at least one selected from the group consisting of a silicon oxide, a tin oxide, an indium oxide, a zinc oxide, and a lithium oxide.

Such an oxide may be amorphous as its structural form. This is because deterioration due to nonuniformity such as crystal grain boundaries or defects is less likely to be caused.

The lithium alloy of the negative electrode active material may be any alloy of metal that can be alloyed with lithium, and may be, for example, a binary, ternary, or higher alloy of lithium and a metal such as Al, Si, Pb, Sn, In, Bi, Ag, Ba, Ca, Hg, Pd, Pt, Te, Zn, or La.

Such an alloy is preferably amorphous as its structural form. This is because deterioration due to nonuniformity such as crystal grain boundaries or defects is less likely to be caused.

The binder that can be included in the negative electrode material layer is not particularly limited, and examples thereof include a polymer compound. Specific examples thereof include at least one selected from the group consisting of a styrene-butadiene-based rubber, a polyacrylic acid, a polyimide-based resin, a polyamideimide-based resin, a polyvinylidene fluoride, a vinylidene fluoride-hexafluoropropylene copolymer, a vinylidene fluoride-tetrafluoroethylene copolymer, and a polytetrafluoroethylene.

The conductive auxiliary agent that can be included in the negative electrode material layer is not particularly limited, and examples thereof can include at least one selected from the group consisting of carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, polyphenylene derivatives, and the like.

The thickness dimension of the negative electrode material layer is not particularly limited, and may be 1 μm or more and 300 μm or less, and is, for example, 5 μm or more and 200 μm or less. The thickness dimension of the negative electrode material layer is a thickness inside the secondary battery, and the average value of measured values at random 10 points may be employed.

The positive electrode current collector and the negative electrode current collector which can be used for the positive electrode and the negative electrode are members that can collect and supply electrons generated in the electrode active material due to the battery reaction. Such an electrode current collector may be a sheet-like metal member. Such an electrode current collector may have a porous or perforated form. For example, the current collector may be a plate, a metal foil, a punching metal, a net, an expanded metal, or the like.

The positive electrode current collector used for the positive electrode may be formed of a metal foil containing at least one selected from the group consisting of aluminum, stainless steel (SUS), nickel, and the like. The positive electrode current collector may be, for example, an aluminum foil.

The negative electrode current collector used for the negative electrode may be formed of a metal foil containing at least one selected from the group consisting of copper, stainless steel (SUS), nickel, and the like. The negative electrode current collector may be, for example, a copper foil.

In the present disclosure, “stainless steel” (SUS) refers to, for example, stainless steel defined in “JIS G 0203 Glossary of terms used in iron and steels” and may be alloy steel containing chromium or containing chromium and nickel.

The thickness dimension of each of the positive electrode current collector and the negative electrode current collector is not particularly limited, and may be 1 μm or more and 150 μm or less, and is, for example, 1 μm or more and 100 μm or less. The thickness dimension of each of the positive electrode current collector and the negative electrode current collector is the thickness inside the secondary battery, and an average value of measured values at optional 10 points may be adopted.

The separator that can be used for the positive electrode and the negative electrode is a member that can be provided from the viewpoint of preventing a short circuit due to contact between the positive electrode and the negative electrode, holding the electrolyte, and the like. In other words, it can be said that the separator is a member that can allow ions to pass while preventing electronic contact between the positive electrode and the negative electrode.

For example, the separator may be a porous or microporous insulating member, and have a membrane form due to its small thickness. By way of example only, a microporous membrane made of a polyolefin may be used as the separator.

The microporous membrane which may be used as the separator may contain, for example, only polyethylene (PE) or a material containing only polypropylene (PP), as polyolefin. Furthermore, the separator may be a laminate which can be formed of a “microporous membrane formed of PE” and a “microporous membrane formed of PP”. The surface of the separator may be covered with an inorganic particle covering layer and/or an adhesive layer. The surface of the separator may have adhesiveness.

The thickness dimension of the separator is not particularly limited, and may be 1 μm or more and 100 μm or less, and is, for example, 2 μm or more and 30 μm or less. The thickness dimension of the separator is a thickness inside the secondary battery (particularly, the thickness between the positive electrode and the negative electrode), and the average value of measured values at random 10 points may be employed.

In the present disclosure, the separator is not to be particularly limited by its name, and may be solid electrolytes, gel-like electrolytes, and/or insulating inorganic particles that can have a similar function.

In the secondary battery according to an embodiment of the present disclosure, for example, an electrode assembly formed by stacking at least one electrode constituting layer including a positive electrode, a negative electrode, and a separator may be covered with an exterior body together with an electrolyte. The electrolyte can assist the movement of metal ions released from the electrodes (positive electrode and/or negative electrode). The electrolyte may be a “non-aqueous” electrolyte containing, for example, a non-aqueous or organic electrolyte and/or a solvent, or may be an “aqueous” electrolyte containing water.

When the positive electrode and the negative electrode have, for example, a layer capable of occluding and releasing lithium ions, the electrolyte may be a lithium-in-containing electrolyte or a “non-aqueous” electrolyte (hereinafter, referred to as a “non-aqueous electrolyte”) containing a non-aqueous or organic electrolyte and/or a solvent. More specifically, the electrolyte may be a non-aqueous electrolyte. In the electrolyte, metal ions released from the electrode (positive electrode and/or negative electrode) are present, and the electrolyte can thus assist the movement of metal ions in the battery reaction.

The secondary battery according to an embodiment of the present disclosure may be a non-aqueous electrolyte secondary battery using a “non-aqueous” electrolyte containing a “non-aqueous” solvent and a solute as an electrolyte. The electrolyte may have a form such as a liquid form or a gel form (in the present specification, the “liquid” non-aqueous electrolyte is also referred to as a “non-aqueous electrolyte solution”).

The non-aqueous electrolyte may be an electrolyte containing a non-aqueous solvent and a solute. A specific solvent for the non-aqueous electrolyte may contain at least a carbonate. Such a carbonate may be cyclic carbonates and/or chain carbonates.

Although not particularly limited, examples of the cyclic carbonates include at least one selected from the group consisting of a propylene carbonate (PC), an ethylene carbonate (EC), a butylene carbonate (BC), and a vinylene carbonate (VC).

Examples of the chain carbonates include at least one selected from the group consisting of a dimethyl carbonate (DMC), a diethyl carbonate (DEC), an ethyl methyl carbonate (EMC), and a dipropyl carbonate (DPC).

Although it is merely an example, in one preferred embodiment of the present disclosure, a combination of cyclic carbonates and chain carbonates may be used as the non-aqueous electrolyte, and for example, a mixture of ethylene carbonate (EC) and diethyl carbonate (DEC), a mixture of ethylene carbonate (EC) and ethyl methyl carbonate (EMC), or the like may be used. As a specific solute of the non-aqueous electrolyte, for example, a Li salt such as LiPF₆ and/or LiBF₄ may be used.

In the present disclosure, the “exterior body” of the secondary battery generally means a member capable of covering an electrode assembly in which at least one electrode constituting layer including a positive electrode, a negative electrode, and a separator is stacked. The exterior body may include an exterior body having electrical conductivity or conductivity. Alternatively, the exterior body may be formed of a laminate film or the like.

In the present disclosure, the “electrode lead” means a conductive member that can be electrically connected to the positive electrode and/or the negative electrode of the electrode assembly, and can protrude or extend from the electrode assembly.

Such an electrode lead may extend from the “positive electrode current collector” and/or the “negative electrode current collector” described above, and may be integrally formed of the same material as the current collector.

In the present disclosure, the above configuration may be appropriately changed or modified as necessary.

In the conventional secondary battery, since stress concentrates on, for example, a portion indicated by an arrow in FIG. 19, particularly, a root portion of a protruding electrode lead 111 at the time of use and/or during use, it has been found that the protruding portion of the electrode lead 111 is bent up and down along a broken line L, for example, whereby the electrode lead 111 is broken.

In other words, it has been found that the electrode lead 111 is broken as edge portions of upper and lower two insulating members (112a, 112b) are aligned with each other along the broken line L illustrated in FIG. 19.

In particular, it has been found that the electrode lead 111 is easily broken when the electrode lead 111 includes a very thin member such as a metal foil.

Thus, the inventor of the present application has studied reinforcing the electrode lead by covering the protruding portion of the electrode lead with a resin member (see FIG. 2).

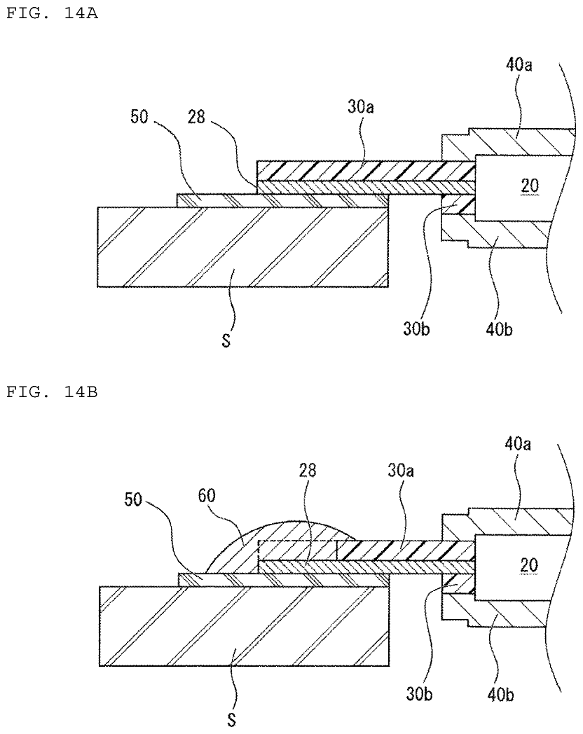

As a result of intensive studies, it has been found that the electrode lead can be reinforced by covering the protruding portion of the electrode lead with the resin member, and at the time of use, for example, as illustrated in FIGS. 14A and 14B, the electrode lead (28) reinforced with the resin member (30a) can be placed on a circuit (50) of a substrate (S) (FIG. 14A) and the electrode lead (28) and the circuit (50) can be electrically connected with solder (60) and the like (see FIG. 14B). At this time, since the root portion (portion on the battery body side) of the electrode lead (28) is in a state of being reinforced by the resin member (30a), it has been found that the electrode lead (28) can be sufficiently reinforced (see FIG. 14B).

The secondary battery of the present disclosure includes, as a basic configuration, an electrode assembly formed by stacking at least one electrode constituting layer including a positive electrode, a negative electrode, and a separator, and an exterior body covering such an electrode assembly.

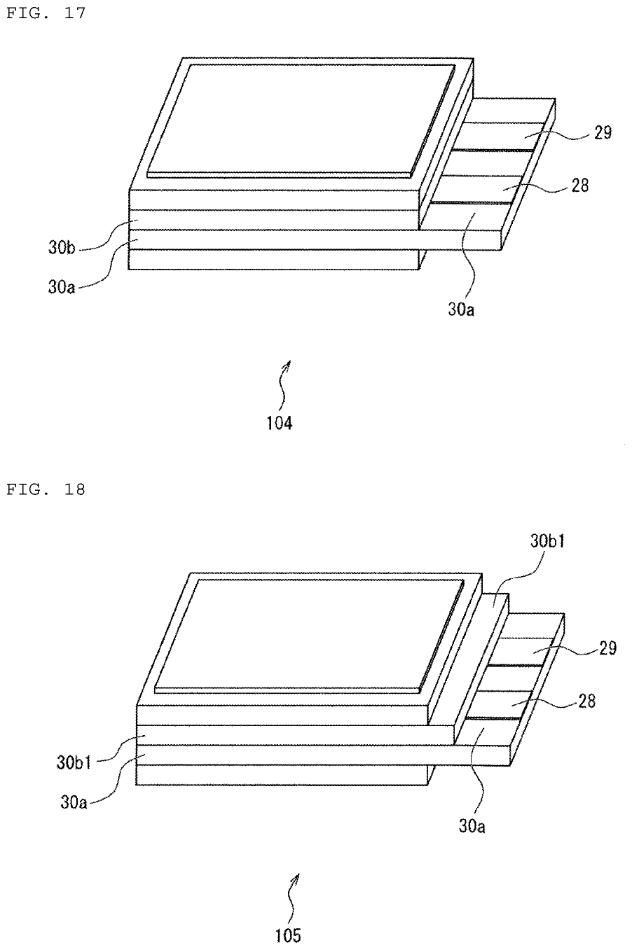

For example, as illustrated in FIG. 2, in the secondary battery according to an embodiment of the present disclosure, the current collector that can extend from a positive electrode and/or a negative electrode of an electrode assembly (not shown) may protrude as the electrode lead (28) from the exterior body (40) (more specifically, an exterior body that can include a first exterior sheet 40a and a second exterior sheet 40b to be described in detail below). For convenience of description, only one electrode lead (28) is illustrated in FIG. 2; however, in the secondary battery of the present disclosure, two electrode leads (positive electrode lead and negative electrode lead) may protrude (see FIG. 17).

In the secondary battery according to an embodiment of the present disclosure, for example, the entire one main surface of the protruding portion (P) of the current collector that may protrude from the exterior body (40) may be covered with the resin member (30).

In the present disclosure, the “electrode lead” (28) generally means a conductive member that can be electrically connected to the positive electrode or the negative electrode that can be included in the electrode assembly.

In the present disclosure, the “protruding portion” (P) generally means a portion where the “electrode lead” (28) protrudes from the exterior body in “plan view” or “top view”.

In the protruding portion (P), the entire one main surface of the electrode lead (28) is covered with the resin member (30) and desirably supported, so that the electrode lead (28), particularly the protruding portion (P) can be reinforced. With such a configuration, it is possible to significantly suppress breakage or tear due to bending of the electrode lead (28), particularly the protruding portion (P) thereof (see FIG. 19).

In the secondary battery of the present disclosure, such a resin member (30) may extend beyond the protruding portion (P) of the electrode lead (28).

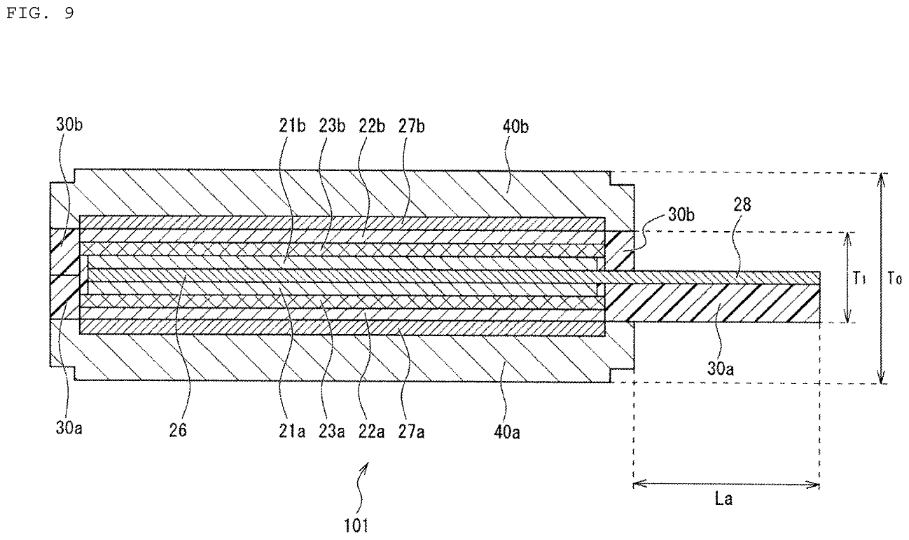

In the secondary battery according to an embodiment of the present disclosure, at least a part of the current collector may be sandwiched by the resin member (30) inside or an inner portion of the exterior body (40) (see FIG. 9). With such a configuration, a part of the electrode lead (28), more specifically, the root portion of the protruding portion (P) can be supported by the resin member (30) in the battery body.

The secondary battery of the present disclosure can be used in various fields, particularly in fields such as electric and electronic devices. In the secondary battery of the present disclosure, at least one main surface of the protruding portion (P) of the electrode lead (28) is covered and reinforced by the resin member (30) (see FIG. 2). With such a configuration, for example, as illustrated in FIG. 14, by placing the electrode lead (28) on the circuit (50) provided on a desired substrate (S), an electrical contact can be formed between the electrode lead (28) and the circuit (50) (see FIG. 14 (A)).

In the aspect illustrated in FIG. 14, a resin film (30a) as the resin member (30) is disposed on the electrode lead (28); however, by applying the “solder” (60) from above the resin film, an electrical contact that can be formed between the electrode lead (28) and the circuit (50) can be fixed. At this time, a part of the resin film (30a) (for example, a broken line portion illustrated in FIG. 14 (B)) may be melted by heat and removed. With such a configuration, it is possible to provide a more improved electrical connection between the electrode lead (28) and the circuit (50).

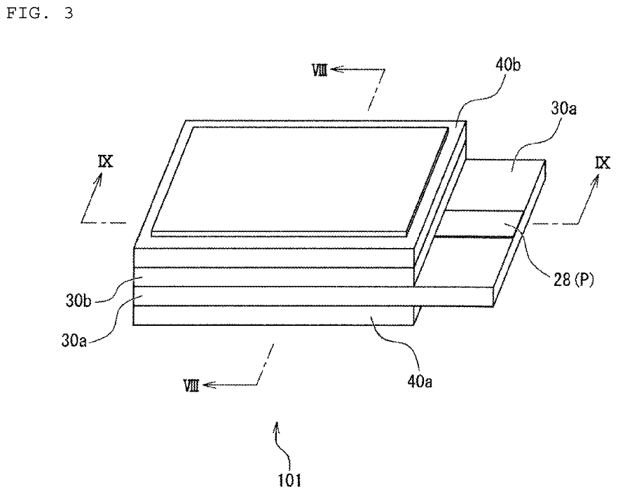

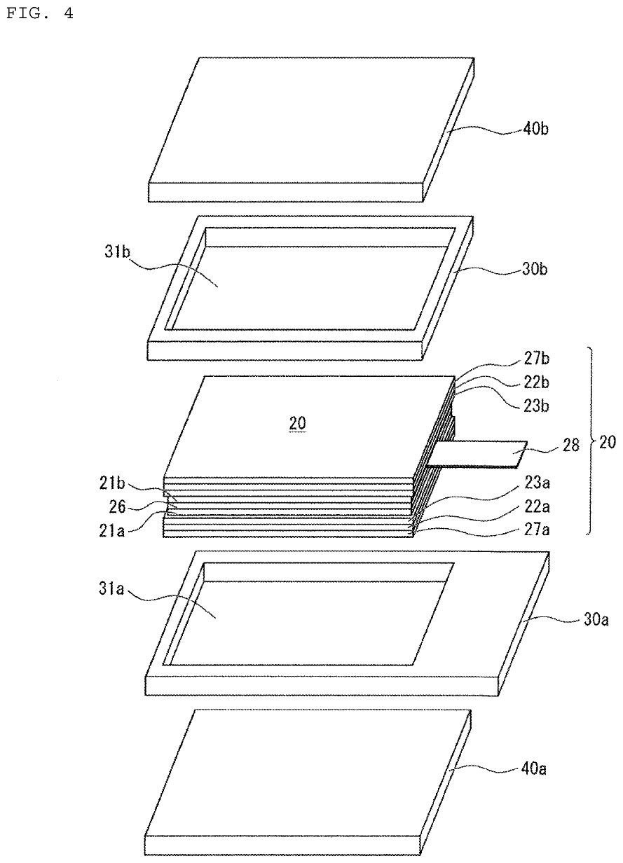

For example, as illustrated in FIGS. 3 and 4, the resin member may include two or more layers, and may include, for example, two resin films (30a, 30b) (see FIG. 4).

FIG. 3 illustrates a secondary battery 101 according to a first embodiment of the present disclosure. For convenience of description, a resin member includes two resin films, specifically, a first resin film 30a and a second resin film 30b. With such a configuration, an electrode lead 28 can be reinforced more easily and reliably.

A secondary battery 101 according to the first embodiment includes a first exterior sheet 40a and a second exterior sheet 40b as exterior bodies. In the secondary battery of the present disclosure, the first exterior sheet 40a and the second exterior sheet 40b as illustrated in FIG. 3 may be formed by bending and arranging one exterior sheet. Alternatively, the exterior body may have a bag shape or a pouch shape.

The structure of the secondary battery 101 according to the first embodiment, particularly the internal structure of the secondary battery 101 will be described with reference to FIGS. 4 to 9. The secondary battery according to the present disclosure should not be construed as being limited to the illustrated form.

First, a method of manufacturing the secondary battery 101 according to the first embodiment will be briefly described with reference to FIG. 4.

The secondary battery 101 according to the first embodiment includes an electrode assembly 20. The electrode assembly 20 will be described in detail below with reference to, for example, FIG. 7. For convenience of description, as an example, the electrode assembly 20 is formed by stacking a positive electrode layer 21 (more specifically, a positive electrode layer including a first positive electrode material layer 21a, a second positive electrode material layer 21b, and a positive electrode current collector 26), a negative electrode layer 22 (more specifically, two negative electrode layers (a “first negative electrode layer” including a first negative electrode material layer 22a and a first negative electrode current collector 27a and a “second negative electrode layer” including a second negative electrode material layer 22b and a second negative electrode current collector 27b), and a separator 23 (more specifically, the first separator 23a and the second separator 23b). Each configuration of the electrode assembly 20 may be appropriately changed within a range of functioning as a battery. For example, the positive electrode layer 21 may be a negative electrode layer, or the negative electrode layer 22 may be a positive electrode layer. The number of layers may be appropriately changed.

The positive electrode lead (28) may protrude from the positive electrode current collector (26) that may be included in the electrode assembly 20 (hereinafter, the electrode lead may be referred to as an “electrode lead” or simply as a “lead” without distinguishing positive and negative). The positive electrode lead (28) may be formed of the same material as the positive electrode current collector 26. Alternatively, the positive electrode lead may be formed of another material as a separate member, and such a separate member may be electrically connected to the positive electrode current collector 26. The shape of the positive electrode lead (28) is not particularly limited, and may have, for example, a plate shape, preferably a belt shape.

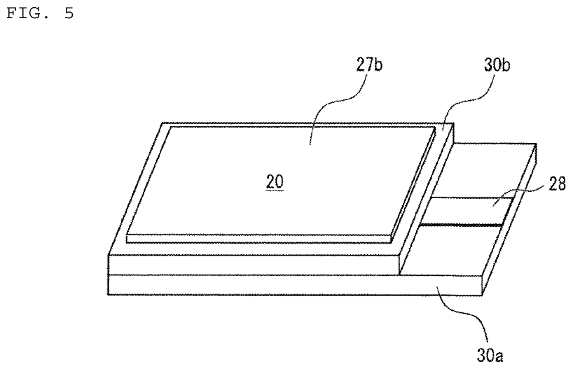

As illustrated in FIGS. 4 and 5, a resin member may be disposed around the electrode assembly 20, particularly at a peripheral edge portion of the electrode assembly 20. More specifically, the first resin film 30a and the second resin film 30b may be arranged at the peripheral edge portion of the electrode assembly 20.

In the present disclosure, the “peripheral edge portion of the electrode assembly” generally means a portion excluding a main surface of the electrode assembly. For example, when the electrode assembly has a plate shape having two main surfaces, the electrode assembly means a surface excluding the two main surfaces.

The first resin film 30a and the second resin film 30b may have a first opening 31a and a second opening 31b, respectively, and a main body portion of the electrode assembly 20 can be positioned through such an opening (see FIG. 5).

In the present disclosure, the main body portion of the electrode assembly generally means a laminated structure portion excluding an electrode lead and the like of the electrode assembly.

FIG. 5 illustrates a state in which the main body portion of the electrode assembly 20 is positioned and disposed in the first opening 31a of the first resin film 30a and the second opening 31b of the second resin film 30b. At this time, at least a part of the positive electrode lead 28 that can extend from the positive electrode current collector 26 can be sandwiched between the first resin film 30a and the second resin film 30b, and the remaining part can be supported as the protruding portion (P) by the first resin film 30a.

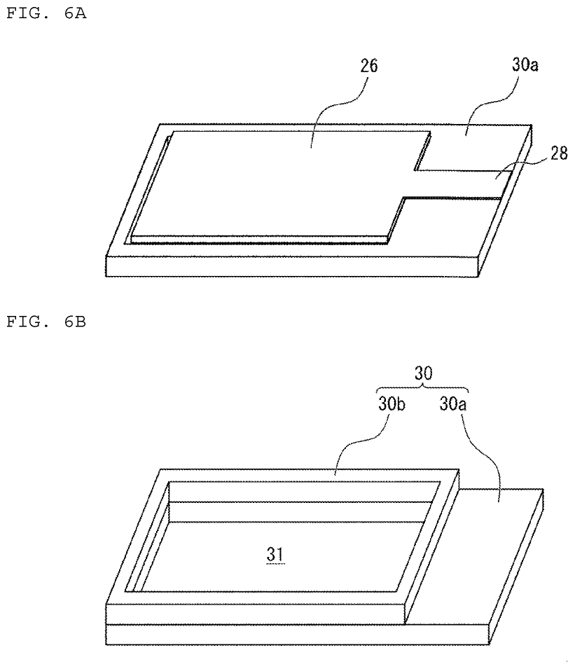

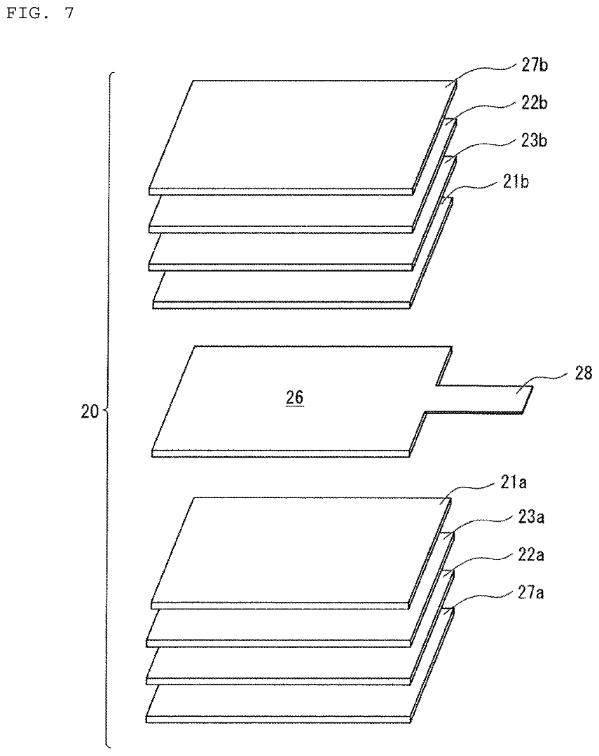

FIG. 6A illustrates a positional relationship between the positive electrode current collector 26 and the first resin film 30a. FIG. 6B illustrates a relationship between the first resin film 30a and the second resin film 30b. The first resin film 30a and the second resin film 30b may be integrated to form the resin member 30. In this case, the first opening 31a of the first resin film 30a and the second opening 31b of the second resin film 30b may be combined with each other to form one opening 31. In FIG. 6B, for convenience of description, the positive electrode current collector 26 is omitted.

As described in detail below, the first resin film 30a and/or the second resin film 30b may have a heat sealing property, and the first resin film 30a and the second resin film 30b can be bonded to each other by such thermal fusion bonding (see FIG. 6B).

FIG. 7 schematically illustrates a configuration of the electrode assembly 20. The electrode assembly 20 may generally include a positive electrode layer, a negative electrode layer, and a separator located therebetween. In other words, the electrode assembly 20 may include at least one electrode constituting layer.

More specifically, the electrode assembly 20 may include the positive electrode current collector 26, and the positive electrode lead 28 may extend from the positive electrode current collector 26. The positive electrode lead 28 may be formed of the same material as or a different material from the positive electrode current collector 26. From the viewpoint of producing a thin secondary battery, both the positive electrode current collector 26 and the positive electrode lead 28 are preferably produced from a metal foil. The first positive electrode material layer 21a and the second positive electrode material layer 21b may be arranged so as to sandwich the positive electrode current collector 26. The first separator 23a may be disposed so as to be interposed between the first positive electrode material layer 21a and the first negative electrode material layer 22a. The second separator 23b may be disposed so as to be interposed between the second positive electrode material layer 21b and the second negative electrode material layer 22b. The first negative electrode current collector 27a may be disposed so as to directly face the first negative electrode material layer 22a, and the second negative electrode current collector 27b may be disposed so as to directly face the second negative electrode material layer 22b.

The positive electrode current collector 26, the first positive electrode material layer 21a, and the second positive electrode material layer 21b may be collectively referred to as a “positive electrode layer” (21). Only one of the first positive electrode material layer 21a and the second positive electrode material layer 21b may be disposed.

The first negative electrode material layer 22a and the first negative electrode current collector 27a may be collectively referred to as a “first negative electrode layer”. The second negative electrode material layer 22b and the second negative electrode current collector 27b may be collectively referred to as a “second negative electrode layer”. In the present disclosure, the “first negative electrode layer” and the “second negative electrode layer” can also be collectively referred to as a “negative electrode layer” (22).

Only one of the “first negative electrode layer” and the “second negative electrode layer” may be disposed.

The configuration of the electrode assembly 20 should not be construed as being limited to the above.

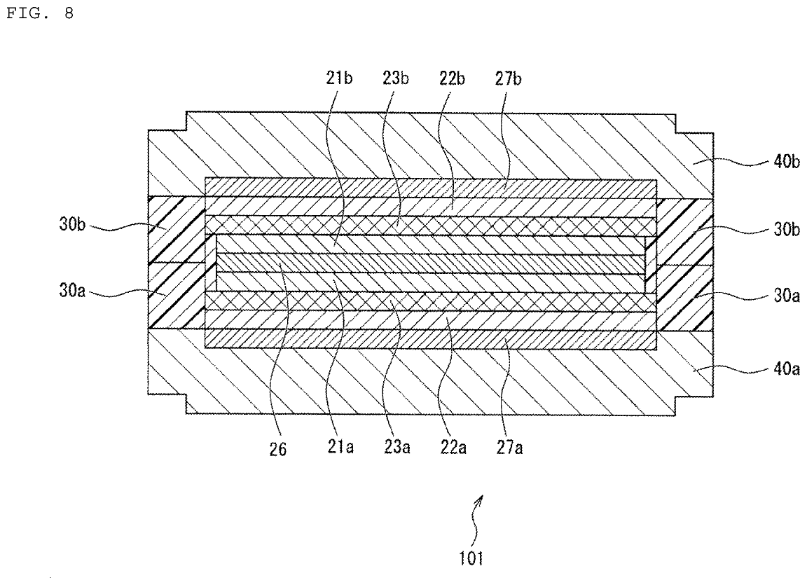

For example, FIG. 8 schematically illustrates a cross section (VIII-VIII) in a width direction of the secondary battery 101 illustrated in FIG. 3, and FIG. 9 schematically illustrates a cross section (IX-IX) in a longitudinal direction. FIGS. 3, 8, and 9 schematically illustrate the secondary battery 101 according to the first embodiment, and the appearance, the dimensional ratio, and the like may be different from the actual ones.

For example, the first exterior sheet 40a and the second exterior sheet 40b are arranged so as to be abutted against the electrode assembly 20 and/or the resin member 30 (specifically, the first resin film 30a and the second resin film 30b) (see FIG. 4), and pressed while being heated, whereby the secondary battery 101 according to the first embodiment as illustrated in FIG. 3 can be produced, for example. At this time, although a step may be formed at edge portions of the surfaces of the first exterior sheet 40a and the second exterior sheet 40b (see FIG. 3), such a step is not an essential configuration of the present application, and may be present or may not be present.

Hereinafter, the “exterior body”, the “resin member”, and the “electrode lead” will be described in detail.

The exterior body is, for example, a component or a member that can be disposed opposite to two main surfaces of the electrode assembly, and generally has a plate shape, preferably a sheet shape. When the exterior body has a sheet shape, the exterior body may be formed of one sheet or two sheets.

For example, as illustrated in FIG. 4, the exterior body may include two exterior sheets, for example, the first exterior sheet 40a and the second exterior sheet 40b. For convenience of description, the lower sheet is referred to as a “first exterior sheet”, and the upper sheet is referred to as a “second exterior sheet”. The shapes of the first exterior sheet and the second exterior sheet in a top view are not particularly limited, and may be a rectangular shape as in the illustrated form or any other geometric shape other than the rectangular shape.

The first exterior sheet and the second exterior sheet may each independently include a metal plate, a clad material, or a laminate film. As the first exterior sheet and the second exterior sheet, the same kind of material may be used, or different kinds of materials may be used. When the same kind of material is used, the first exterior sheet and the second exterior sheet may be continuous. Such an exterior body can be formed by bending the same material. The exterior body may have a bag shape or a pouch shape.

As the “metal plate”, for example, a plate-shaped or band-shaped material made of aluminum, copper, stainless steel (SUS), nickel, or the like can be used without particular limitation.

In the metal plate, “stainless steel” (SUS) refers to, for example, stainless steel defined in “JIS G 0203 Glossary of terms used in iron and steels” and may be alloy steel containing chromium or containing chromium and nickel.

In the present disclosure, the “plate shape” means a structure having two main surfaces that are parallel or substantially parallel. In the present disclosure, the term “band shape” means a structure having two main surfaces parallel or substantially parallel and having a longitudinal direction and a width direction perpendicular to the longitudinal direction.

The thickness of the metal plate is, for example, 0.01 mm or more and 0.250 mm or less.

In the present disclosure, the “clad material” means a member formed by simultaneously rolling and joining a plurality of metal materials.

The clad material may be made of, for example, at least two kinds of metal materials selected from the group consisting of aluminum, copper, stainless steel (SUS), and nickel.

The entire thickness of the clad material is, for example, 0.01 mm or more and 0.250 mm or less.

The “laminate film” generally means a laminated structure. Examples of the laminate film include a laminate film include a metal sheet (a metal sheet that can include the above-mentioned metal plate and clad material)/a fusion layer (a fusion layer that can include a resin member, particularly a resin sheet, which will be described in detail below)/a protective layer (a protective layer that can include a polymer material or the like), and a laminate film in which the above-mentioned metal plate or clad material is covered with a resin member, particularly a resin sheet, which will be described in detail below. When a resin member described in detail below, particularly a laminate film coated with a resin sheet, is used for the metal plate or the clad material, the presence of the resin member described in detail below may be excluded.

The total thickness of the laminate film is, for example, 0.06 mm or more and 0.30 mm or less.

The exterior body preferably include a metal plate or a clad material. When the exterior body includes a metal plate or a clad material, such an exterior body may be electrically connected to the positive electrode or the negative electrode of the electrode assembly, and can function as a positive electrode terminal or a negative electrode terminal.

For example, in the mode illustrated in FIG. 3, the first exterior sheet 40a is electrically connected to the first negative electrode layer (specifically, the first negative electrode current collector 27a) of the electrode assembly 20, and the second exterior sheet 40b is electrically connected to the second negative electrode layer (specifically, the second negative electrode current collector 27b) of the electrode assembly 20 (see FIG. 8). As a result, both the first exterior sheet 40a and the second exterior sheet 40b can function as negative electrode terminals.

When the exterior body includes a laminate film, for example, as illustrated in FIG. 17, each of the positive electrode lead 28 and the negative electrode lead 29 may protrude from the exterior body.

In the present disclosure, the “resin member” means a member that can include a resin material or an elastomer material in a broad sense, and means a member that can include a resin material or an elastomer material having “insulating properties” in a narrow sense. The resin member preferably has not only “insulating properties” but also “heat sealing property” (or heat adhesiveness).

It is more preferable that the resin member includes a resin having “insulating properties” and “heat sealing property”.

In the present disclosure, the “insulating properties” means electrical insulating properties in a broad sense, and means insulating properties capable of preventing an electrical short circuit with the electrode assembly, particularly the positive electrode and the negative electrode in a narrow sense.

In the present disclosure, the “heat sealing property” generally means a property that exhibits adhesiveness by heating.

When the resin member has both the “insulating properties” and the “heat sealing property”, the insulating properties and the sealing property with respect to the electrode assembly, the bonding property with respect to the exterior body, and the like are improved.

As the resin member, a thermoplastic resin, preferably a heat-sealable resin can be used. Examples of the thermoplastic resin include a polyolefin-based resin such as polyethylene and/or polypropylene, preferably polypropylene, and a copolymer thereof. As the resin member, a single-layer film of a thermoplastic resin or a multilayer film containing a thermoplastic resin can be used. Examples of the multilayer film include a multilayer heat-sealable film in which both surfaces of a high-melting-point resin layer to be an intermediate layer are sandwiched between low-melting-point resin layers (thermoplastic resin layers). Examples of the elastomer material include polyester-based thermoplastic elastomers.

Viewed from another aspect, the resin member may contain a component of an adhesive that exhibits insulating properties. Examples of such an adhesive include an acrylic-based adhesive such as an acrylic acid ester copolymer, a rubber-based adhesive such as natural rubber, a silicone-based adhesive such as silicone rubber, a urethane-based adhesive such as urethane resin, an α-olefin-based adhesive, an ether-based adhesive, an ethylene-vinyl acetate-based resin adhesive, an epoxy resin-based adhesive, a vinyl chloride resin-based adhesive, a chloroprene rubber-based adhesive, a cyanoacrylate-based adhesive, an aqueous polymer-isocyanate-based adhesive, a styrene-butadiene rubber-based adhesive, a nitrile rubber-based adhesive, a nitrocellulose-based adhesive, a reactive hot-melt-based adhesive, a phenol resin-based adhesive, a modified silicone-based adhesive, a polyamide resin-based adhesive, a polyimide-based adhesive, a polyurethane resin-based adhesive, a polyolefin resin-based adhesive, a polyvinyl acetate resin-based adhesive, a polystyrene resin solvent-based adhesive, a polyvinyl alcohol resin-based adhesive, a polyvinyl pyrrolidone resin-based adhesive, a polyvinyl butyral resin-based adhesive, a polybenzimidazole-based adhesive, a polymethacrylate resin-based adhesive, a melamine resin-based adhesive, an urea resin-based adhesive, and/or a resorcinol-based adhesive.

The resin member may have a film form. That is, the resin member may have a film form, that is, a thin plate-like form.

The thickness of the resin member is not particularly limited. For example, as illustrated in FIG. 9, the total thickness (Ti) of the current collector and the two resin films is preferably smaller than a total thickness (To) of the secondary battery (T₁<T₀).

As the resin member, two resin films may extend inside the exterior body and be bonded to each other (see FIGS. 2 and 4 to 6B). With such a configuration, airtightness to the electrode assembly can be further improved.

As the resin member, each of at least a part of the two resin films may be joined to the exterior body (see FIG. 3). With such a configuration, the sealing property of the secondary battery can be further improved.

As the resin member, each of the two resin films may have an opening, and the electrode assembly may be positioned inside the opening (see FIGS. 4 to 6B). The position where the opening is formed in the resin film is not particularly limited. Such openings may or may not be present. Due to the presence of the opening, the secondary battery can be downsized, particularly thinned.

A secondary battery of the present disclosure includes a positive electrode lead that can be electrically connected to a positive electrode that can be included in an electrode assembly and/or a negative electrode lead that can be electrically connected to a negative electrode that can be included in the electrode assembly.

In the present disclosure, the “positive electrode lead” means a conductor that can be electrically connected to the positive electrode that can be included in the electrode assembly. In the present disclosure, the “negative electrode lead” means a conductor that can be electrically connected to the negative electrode that can be included in the electrode assembly. The material contained in such a conductor is not particularly limited, and is selected from the group consisting of, for example, aluminum, copper, stainless steel (SUS), nickel, and the like. The positive electrode lead may be one in which the positive electrode current collector extends or another member separately prepared from the above material. The negative electrode lead may be one in which the negative electrode current collector extends or another member separately prepared from the above material. Both or one of the positive electrode lead and the negative electrode lead may be present. The shape of the positive electrode lead and/or the negative electrode lead is not particularly limited. From the viewpoint of forming a thin battery, the positive electrode lead and/or the negative electrode lead preferably have a belt-like or film-like form.

The thickness of the electrode lead such as the positive electrode lead and/or the negative electrode lead is not particularly limited, and is, for example, 0.005 mm or more and 0.15 mm or less, preferably 0.01 mm or more and 0.10 mm or less.

The dimension in the longitudinal direction of the electrode lead such as the positive electrode lead and/or the negative electrode lead is not particularly limited, and is, for example, 5 mm or more and 50 mm or less, and preferably 10 mm or more and 30 mm or less.

The dimension in the width direction of the electrode lead such as the positive electrode lead and/or the negative electrode lead is not particularly limited, and is, for example, 0.1 mm or more and 15 mm or less, and preferably 1 mm or more and 10 mm or less.

Each component in the first embodiment may be appropriately changed as necessary.

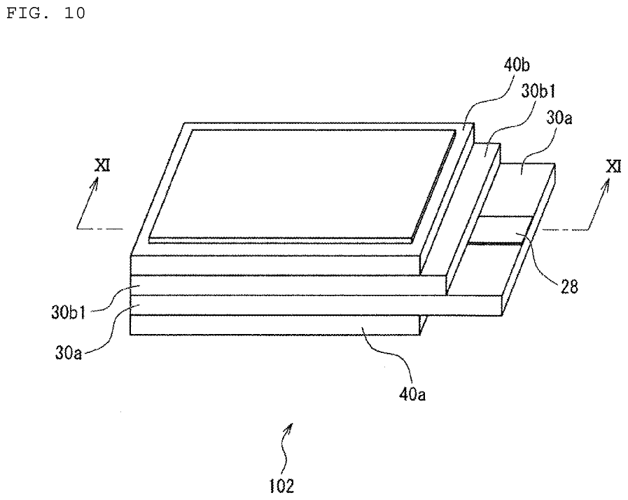

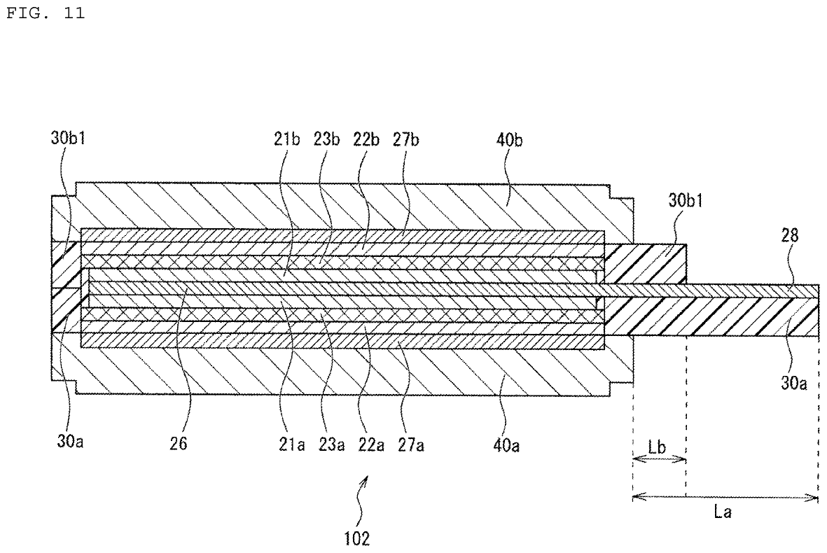

A secondary battery 102 according to a second embodiment of the present disclosure is illustrated in a schematic perspective view of FIG. 10 and a schematic sectional view in a longitudinal direction (XI-XI) (see FIG. 11).

In the second embodiment, the entire one main surface of a protruding portion (or an electrode lead) of a current collector may be covered with one of two resin films (specifically, a first resin film 30a), and at least a part of the other main surface of the protruding portion may be covered with the other of the two resin films (specifically, a second resin film 30b1).

The second embodiment may be configured similarly to the first embodiment except for the second resin film 30b1 (see FIGS. 3 and 10).

Specifically, the second resin film 30b1 according to the second embodiment is characterized by being different in dimension in the longitudinal direction from the second resin film 30b according to the first embodiment. More specifically, the second resin film 30b1 according to the second embodiment may extend from an exterior body toward a tip of an electrode lead 28 along the electrode lead 28.

For example, as illustrated in FIG. 11, a ratio (L_{b}/Lₐ) of a dimension (L_{b}) in the longitudinal direction of the second resin film 30b1 according to the second embodiment to a dimension (Lₐ) in the longitudinal direction of the first resin film 30a according to the second embodiment may be 0 or more and less than 1, and is, for example, 0 or more and ½ or less.

With such a configuration, the electrode lead 28 (protruding portion P) is sandwiched between the first resin film 30a and the second resin film 30b1, and the electrode lead 28 can be further reinforced.

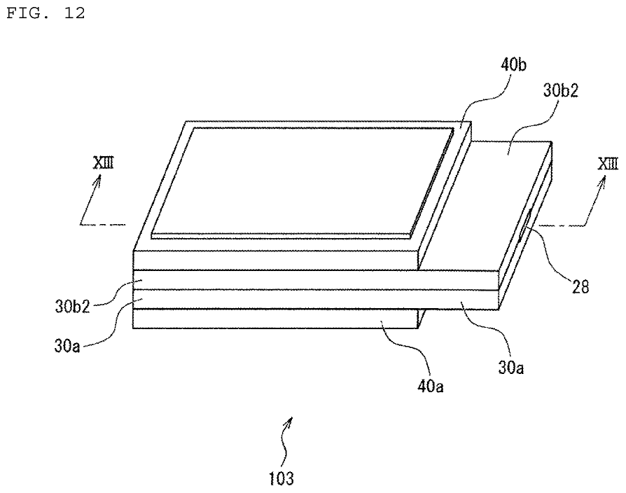

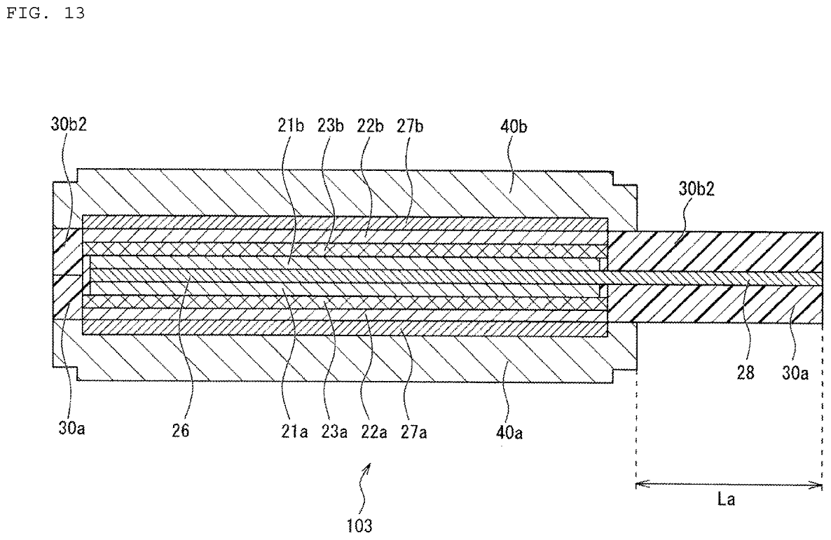

A secondary battery 103 according to a third embodiment of the present disclosure is illustrated in a schematic perspective view of FIG. 12 and a schematic sectional view in a longitudinal direction (XIII-XIII) (see FIG. 13).

In the third embodiment, both surfaces of a protruding portion (or an electrode lead) of a current collector may be covered with two resin films (specifically, a first resin film 30a and a second resin film 30b2).

The third embodiment may be configured similarly to the first embodiment except for the second resin film 30b2 (see FIGS. 3 and 12).

Specifically, the second resin film 30b2 according to the third embodiment is characterized by being different in dimension in the longitudinal direction from the second resin film 30b according to the first embodiment. More specifically, the dimension in the longitudinal direction of the second resin film 30b2 according to the third embodiment may be the same as the dimension (Lₐ) in the longitudinal direction of first resin film 30a according to the first embodiment (see FIG. 13).

With such a configuration, the electrode lead 28 (protruding portion P) is covered and sandwiched by the first resin film 30a and the second resin film 30b2, and the electrode lead 28 can be further reinforced.

### (Mode of Use of Secondary Battery of Present Disclosure)

FIGS. 14A and 14B schematically illustrate a mode of use of the secondary battery 101 (see FIGS. 3 to 9) according to the first embodiment of the present disclosure.

FIG. 14A illustrates a state in which the electrode lead 28 is placed on the circuit 50 provided on the substrate S such as a printed circuit board. A surface of the electrode lead 28 not in contact with the circuit 50 is covered with the first resin film 30a (see FIGS. 3 and 14A). With such a configuration, the electrode lead 28 is reinforced by the first resin film 30a at the time of forming a contact with the circuit 50, and breakage of the electrode lead 28 or rupture or can be suppressed. FIG. 14B illustrates a state in which an electrical contact that can be formed between the electrode lead 28 and the circuit 50 is fixed using the solder 60. At the time of bonding using solder, a part of the first resin film 30a may be dissolved and removed. Such a state makes it possible to form a more excellent electrical contact between the electrode lead 28 and the circuit 50.

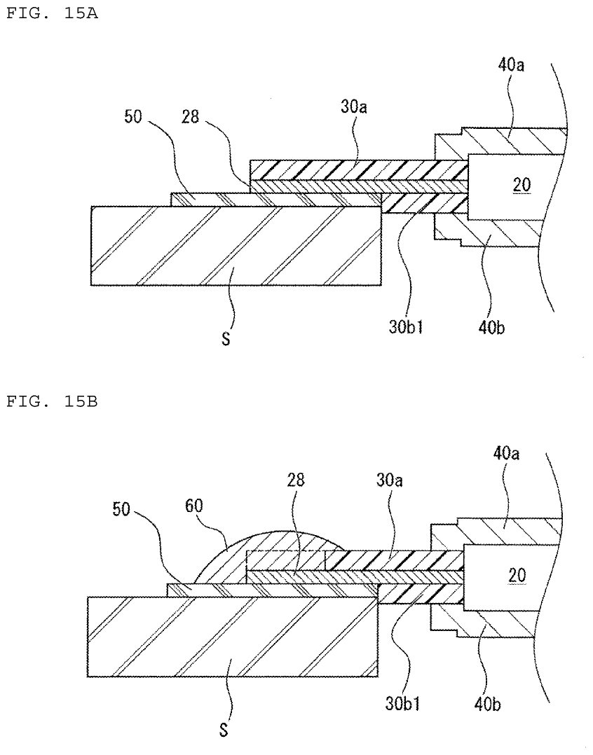

FIGS. 15A and 15B schematically illustrate the mode of use of the secondary battery 102 (see FIGS. 10 and 11) according to the second embodiment of the present disclosure.

FIG. 15A illustrates a state in which the electrode lead 28 is placed on the circuit 50 provided on the substrate S. The surface of the electrode lead 28 not in contact with the circuit 50 is covered with the first resin film 30a. A surface of the electrode lead 28 in contact with the circuit 50 is also covered with the second resin film 30b1 (see FIGS. 10 and 15A). With such a configuration, the electrode lead 28 is reinforced by the first resin film 30a and the second resin film 30b1 at the time of forming a contact with the circuit 50, and breakage of the electrode lead 28 or rupture or can be further suppressed. Similarly to the first embodiment, FIG. 15B illustrates the state in which an electrical contact that can be formed between the electrode lead 28 and the circuit 50 is fixed using the solder 60. Even in such a state, the electrode lead 28 is protected by sandwiching the electrode lead 28 by two resin films (30a, 30b1), so that it is possible to suppress breakage of the electrode lead 28 or rupture.

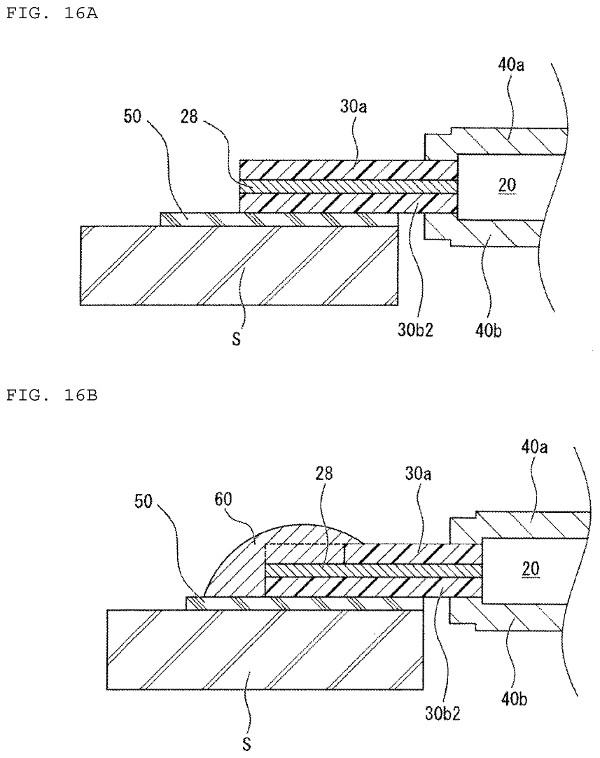

FIGS. 16A and 16B schematically illustrate the mode of use of the secondary battery 103 (see FIGS. 12 and 13) according to the third embodiment of the present disclosure.

FIG. 16A illustrates a state in which the second resin film 30b2 covering the electrode lead 28 is placed on the circuit 50 provided on the substrate S. The other surface of the electrode lead 28 is covered with the first resin film 30a. With such a configuration, the electrode lead 28 is covered and reinforced with the first resin film 30a and the second resin film 30b2, and it is possible to suppress breakage of the electrode lead 28 from both sides or rupture. The second resin film 30b2 can also enhance adhesion to the circuit 50. FIG. 16B illustrates a state in which an electrical path is formed between the electrode lead 28 and the circuit 50 using the solder 60. In this state, a part of the first resin film 30a is removed by heat to expose the electrode lead 28, and the electrode lead 28 thus exposed can form an electrical connection with the circuit 50. The electrode lead 28 and the circuit 50 can be energized from the side surface or the end surface via the solder 60. Even in such a state, the electrode lead 28 is protected by sandwiching the electrode lead 28 by two resin films (30a, 30b2), so that it is possible to suppress breakage of the electrode lead 28 or rupture.

In the first to third embodiments, only one electrode lead is illustrated for convenience of description (see FIGS. 3 to 13); however, two electrode leads (positive electrode lead and negative electrode lead) may be provided. For example, FIG. 17 schematically illustrates a secondary battery 104 according to a fourth embodiment. The secondary battery 104 basically has the same configuration as the secondary battery 101 according to the first embodiment, and includes a positive electrode lead 28 and a negative electrode lead 29. The positive electrode lead 28 can correspond to the electrode lead 28 according to the first embodiment. The negative electrode lead 29 is a member that can extend from a negative electrode, particularly a negative electrode current collector, which can be included in the electrode assembly similarly to the electrode lead 28 according to the first embodiment.

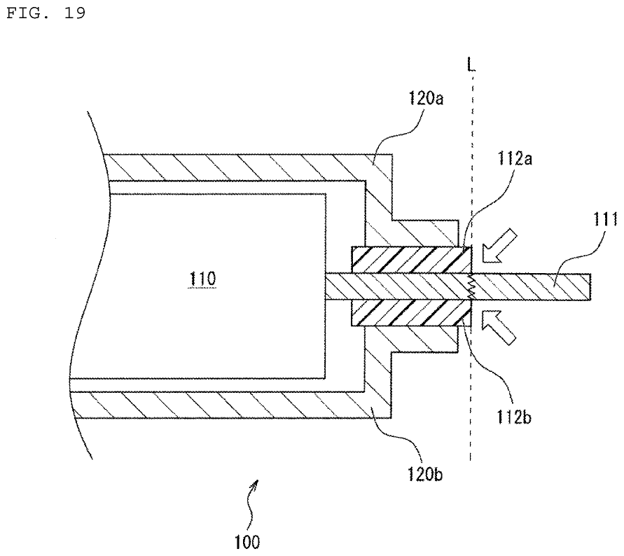

For example, FIG. 18 schematically illustrates a secondary battery 105 according to a fifth embodiment. The secondary battery 105 basically has the same configuration as the secondary battery 102 (see FIG. 10) according to the second embodiment, and includes a positive electrode lead 28 and a negative electrode lead 29′. The positive electrode lead 28 can correspond to the positive electrode lead 28 according to the fourth embodiment (see FIG. 17). Similarly, the negative electrode lead 29′ can correspond to the negative electrode lead 29 according to the fourth embodiment (see FIG. 17).

Similarly to the fourth embodiment and the fifth embodiment, also in the secondary battery 103 (see FIG. 12) of the third embodiment, two electrode leads (positive electrode lead and negative electrode lead) may be provided (sixth embodiment (not illustrated)).

The components in the first to sixth embodiments may be appropriately used in combination as necessary.

The secondary battery according to the first to sixth embodiments of the present disclosure can significantly reinforce the electrode lead. A handling property is improved and connection resistance is reduced at the time of use. An insulating member such as a sealant, which has been conventionally required, becomes unnecessary (see FIG. 19), and the configuration of the secondary battery can be further simplified.

Hereinafter, the present disclosure will be described in more detail with reference to Examples and Comparative Examples.

### EXAMPLES

### Example 1

As the exterior sheet (40a, 40b), a copper plate (T: 0.04 mm×W: 25 mm×L: 50 mm) was used.

An electrode assembly similar to the configuration illustrated in FIG. 7 was prepared as the electrode assembly (W: 18 mm×L: 40 mm).
Second negative electrode current collector 27b: copper foil (Thickness: 12 μm)
Second negative electrode material layer 22b: graphite (Thickness: 48 μm)
Second separator 23b: polypropylene/polyethylene (Thickness: 30 μm)
Second positive electrode material layer 21b: lithium cobalt oxide (Thickness: 50 μm)
Positive electrode current collector 26: aluminum foil (Thickness: 30 μm)
First positive electrode material layer 21a: lithium cobalt oxide (Thickness: 50 μm)
First separator 23a: polypropylene/polyethylene (Thickness: 30 μm)
First negative electrode material layer 22a: graphite (Thickness: 48 μm)
First negative electrode current collector 27a: copper foil (Thickness: 12 μm)
The dimensions of the positive electrode lead 28 were T: 0.03 mm×W: 5 mm×L: 23 mm.

A resin film having the shape illustrated in FIG. 4 was provided as a resin member used in Examples and Comparative Examples.
First resin film 30a: polyolefin-based resin (T: 0.1 mm×W: 25 mm×L: 50 mm)
Second resin film 30b: polyolefin-based resin (T: 0.1 mm×W: 25 mm×L: 50 mm)

The dimensions of the produced secondary battery illustrated in FIG. 9 were as follows.
Lₐ: 15 mm
T₀: 0.390 mm
T₁: 0.230 mm

### Comparative Example 1

A secondary battery of Comparative Example 1 was produced in the same manner as in Example 1 except that the dimension Lₐ of the first resin film 30a of the secondary battery illustrated in FIG. 9 was 0 mm (no protrusion).

### (Evaluation)

The secondary batteries produced in Example 1 and Comparative Example 1 were evaluated by the following cycle test.

### (Cycle Test)

The cycle test was performed using the following steps (1) and (2) as one cycle.
(1) Bend the electrode lead by 90°
(2) Return bent electrode lead to original position

The number of cycles in which the electrode lead was broken was confirmed. The results are shown in Table below.

The number of cycles shown in the following table is an average value of cycle tests performed three times.

TABLE 1

| Test | The number of cycles |
|---|---|
| Example 1 | 57 |
| Comparative Example 1 | 11 |

From the results shown in Table 1, it is demonstrated that the electrode lead is significantly reinforced in the secondary battery of Example 1 (the number of cycles is five times or more).

The present disclosure is described below in further detail according to an embodiment.

<1>

A secondary battery including:
an electrode assembly formed by stacking at least one electrode constituting layer including a positive electrode, a negative electrode, and a separator; and
an exterior body covering the electrode assembly,
wherein a current collector extending from the positive electrode and/or the negative electrode of the electrode assembly protrudes as an electrode lead from the exterior body, the entire one main surface of a protruding portion of the current collector protruding from the exterior body is covered with a resin member, and at least a part of the current collector is sandwiched by the resin member inside the exterior body.
   <2>

The secondary battery according to <1>, wherein the resin member includes two resin films.

<3>

The secondary battery according to <2>, wherein the entire one main surface of the protruding portion of the current collector is covered with one of the two resin films, and at least a part of the other main surface of the protruding portion is covered with the other of the two resin films.

<4>

The secondary battery according to <2> or <3>, wherein both surfaces of the protruding portion of the current collector are covered with the two resin films.

<5>

The secondary battery according to any one of <2> to <4>, wherein a total thickness of the current collector and the two resin films is smaller than a total thickness of the secondary battery.

<6>

The secondary battery according to any one of <1> to <5>, wherein the resin member includes a resin having insulating properties and a heat sealing property.

<7>

The secondary battery according to any one of <1> to <6>, wherein the resin member includes a polyolefin-based resin.

<8>

The secondary battery according to any one of <2> to <7>, wherein the two resin films extend inside the exterior body and are bonded to each other.

<9>

The secondary battery according to any one of <2> to <8>, wherein each of at least a part of the two resin films is joined to the exterior body.

<10>

The secondary battery according to any one of <2> to <9>, wherein each of the two resin films has an opening, and the electrode assembly is positioned inside the opening. <11>

The secondary battery according to any one of <1> to <10>, wherein the exterior body includes a metal plate, a clad material, or a laminate film.

<12>

The secondary battery according to any one of <1> to <11>, wherein the exterior body includes a metal plate or a clad material, and the exterior body is electrically connected to the positive electrode or the negative electrode of the electrode assembly.

### INDUSTRIAL APPLICABILITY

The secondary battery of the present disclosure can be used in various fields where electric storage is assumed. Although it is merely an example, the secondary battery of the present disclosure can be used in the fields of electricity, information, and communication in which electricity, electronic equipment, and the like are used (for example, electric and electronic equipment fields or mobile equipment fields including mobile phones, smartphones, notebook computers and digital cameras, activity meters, arm computers, electronic papers, and wearable devices, and small electronic machines such as RFID tags, card type electronic money, and smartwatches), home and small industrial applications (for example, the fields of electric tools, golf carts, and home, nursing, and industrial robots), large industrial applications (for example, fields of forklift, elevator, and harbor crane), transportation system fields (field of, for example, hybrid automobiles, electric automobiles, buses, trains, power-assisted bicycles, and electric two-wheeled vehicles), power system applications (for example, fields such as various types of power generation, road conditioners, smart grids, and household power storage systems), medical applications (medical equipment fields such as earphone hearing aids), pharmaceutical applications (fields such as dosage management systems), IoT fields, space and deep sea applications (for example, fields such as a space probe and a submersible), and the like.

### DESCRIPTION OF REFERENCE SYMBOLS

1: Positive electrode
2: Negative electrode
3: Separator
5: Electrode constituting layer
10, 20, 110: Electrode assembly
21: Positive electrode layer
21a: First positive electrode material layer
21b: Second positive electrode material layer
22: Negative electrode layer
22a: First negative electrode material layer
22b: Second negative electrode material layer
23: Separator
23a: First separator
23b: Second separator
26: Positive electrode current collector
27: Negative electrode current collector
27a: First negative electrode current collector
27b: Second negative electrode current collector
28: Electrode lead (positive electrode lead)
29: Electrode lead (negative electrode lead)
30: Resin member
30a: First resin film
30b: Second resin film
31: Opening
31a: First opening
31b: Second opening
40: Exterior body
40a: First exterior sheet
40b: Second exterior sheet
50: Circuit
60: Solder
100, 101, 102, 103, 104, 105: Secondary battery
111: Electrode lead
112: Insulating member
112a: First (upper) insulating member
112b: Second (lower) insulating member
120: Case
120a: First (upper) case
120b: Second (lower) case
P: Current collector (electrode lead) protruding from exterior body
S: Substrate

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode assembly formed by stacking at least one electrode constituting layer including a positive electrode, a negative electrode, and a separator; and
an exterior body covering the electrode assembly,
wherein a current collector extending from one or both of the positive electrode and the negative electrode of the electrode assembly protrudes as an electrode lead from the exterior body, the entire one main surface of a protruding portion of the current collector protruding from the exterior body is covered with a resin member, and at least a part of the current collector is sandwiched by the resin member inside the exterior body.

2. The secondary battery according to claim 1, wherein the resin member includes two resin films.

3. The secondary battery according to claim 2, wherein the entire one main surface of the protruding portion of the current collector is covered with one of the two resin films, and at least a part of the other main surface of the protruding portion is covered with the other of the two resin films.

4. The secondary battery according to claim 2, wherein both surfaces of the protruding portion of the current collector are covered with the two resin films.

5. The secondary battery according to claim 2, wherein a total thickness of the current collector and the two resin films is smaller than a total thickness of the secondary battery.

6. The secondary battery according to claim 1, wherein the resin member includes a resin having insulating properties and a heat sealing property.

7. The secondary battery according to claim 1, wherein the resin member includes a polyolefin-based resin.

8. The secondary battery according to claim 1, wherein the two resin films extend inside the exterior body and are bonded to each other.

9. The secondary battery according to claim 1, wherein each of at least a part of the two resin films is joined to the exterior body.

10. The secondary battery according to claim 1, wherein each of the two resin films has an opening, and the electrode assembly is positioned inside the opening.

11. The secondary battery according to claim 1, wherein the exterior body includes a metal plate, a clad material, or a laminate film.

12. The secondary battery according to claim 1, wherein the exterior body includes a metal plate or a clad material, and the exterior body is electrically connected to the positive electrode or the negative electrode of the electrode assembly.
